(19) United States
(12) Patent Application Publication
(10) Pub. No.: US 2025/0323484 A1
(43) Pub. Date: Oct. 16, 2025

(54) CANTILEVER DEVICE FOR A CHARGING STATION, HOUSING ARRANGEMENT WITH SUCH A CANTILEVER DEVICE AND CHARGING STATION ARRANGEMENT SUCH A CANTILEVER DEVICE

(71) Applicant: ads-tec Energy GmbH, Nürtingen (DE)

(72) Inventors: Thomas SPEIDEL, Markgröningen (DE); Roman MOLCHANOV, Neckartenzlingen (DE)

(21) Appl. No.: 19/046,618

(22) Filed: Feb. 6, 2025

(30) Foreign Application Priority Data
Feb. 9, 2024 (DE) 102024103763.6

(51) Int. Cl. H02G 11/00; B60L 53/18; F21S 4/28; F21Y 103/10; F21Y 115/10

(52) U.S. Cl. CPC H02G 11/003; B60L 53/18; F21S 4/28; F21Y 2103/10; F21Y 2115/10

(57) ABSTRACT

The invention relates to a cantilever device for a charging station with at least one beam, wherein
the at least one beam has a rigid main body with a first end and a second end opposite the first end along a longitudinal extension of the at least one beam, wherein
the cantilever device has a first fastening device for rigidly fastening the first end of the at least one beam to the charging station, wherein
the cantilever device has at least one further fastening device for movably fastening at least one charging cable accommodation and/or at least one roof element.

The invention relates to a cantilever device for a charging station, a housing arrangement with such a cantilever device and a charging station arrangement with such a cantilever device.

Charging stations, in particular fast charging stations for vehicles with an electric drive, are becoming increasingly important. The use of such a charging station should be as simple and convenient as possible for the user. In known charging stations, the length of a charging cable is selected in such a way that the charging cable does not touch the ground where the charging station is installed when it is not in use-if a charging plug of the charging cable is plugged into the charging station. This prevents the charging cable from being soiled and/or damaged by the ground. It also prevents a vehicle from driving over the charging cable and/or parking on it. The disadvantage of this is that the resulting limited length of the charging cable restricts a radius of action of the charging station, in particular a distance between a charging socket of the vehicle to be charged and the charging station. This means that with the known charging stations, it is necessary to park the motor vehicle exactly relative to the charging station or to park it at an angle if the charging socket is arranged on a side of the motor vehicle facing away from the charging station, as otherwise the charging plug cannot be plugged into the charging socket.

Furthermore, charging stations with charging arms are known, wherein the charging arms can be pivoted relative to a housing of the charging station via a folding device. The disadvantage is that these charging arms with the folding device have a complex design. Furthermore, the folding device typically has a restoring device that pushes the charging arm into a resting position by means of a restoring force when not in use. The disadvantage is that a user has to expend force to pivot the charging arm and connect the charging cable to a vehicle to be charged. Furthermore, the restoring force exerts a tensile force on the charging cable when the charging cable is connected to the vehicle to be charged.

The invention is thus based on the object of creating a cantilever device for a charging station, a housing arrangement with such a cantilever device and a charging station arrangement with such a cantilever device, wherein the disadvantages mentioned are at least partially eliminated, preferably avoided.

The object is solved by providing the present technical teaching, in particular the teaching of the independent claims and the embodiments disclosed in the dependent claims and the description.

The object is solved in particular by creating a cantilever device for a charging station with at least one beam. The at least one beam has a rigid main body with a first end and a second end opposite the first end along a longitudinal extension of the beam. Furthermore, the cantilever device has a first fastening device for rigidly fastening the first end of the at least one beam to the charging station. In addition, the cantilever device has at least one further fastening device for movably fastening at least one charging cable accommodation and/or at least one roof element. Advantageously, this provides a retrofittable cantilever device for an existing charging station. Furthermore, by providing the further fastening device, the cantilever device can be flexibly adapted to an intended use—the guiding of a charging cable and/or the roofing of the charging station. Furthermore, the cantilever device can be individually adapted to customer requirements thanks to its modular embodiment.

In particular, the at least one beam projects beyond a geometry of the charging station in the intended fastened state, in particular beyond the dimensions of the housing of the charging station, preferably in all three spatial dimensions. Thus, in the context of the present technical teaching, the at least one beam of the cantilever device forms, in particular, a boom.

In one embodiment, the at least one beam and the first fastening device are formed in a plurality of parts. In addition, the at least one beam and the at least one further fastening device are formed in a plurality of parts.

In a further embodiment, the at least one beam and the first fastening device are formed in one part. Preferably, the at least one beam and the first fastening device are formed from the same material. Furthermore, in particular the at least one beam and the at least one further fastening device are formed in a plurality of parts.

In a further embodiment, the at least one beam and the least one further fastening device are formed in one part. Preferably, the at least one beam and the at least one further fastening device are formed from the same material. Furthermore, in particular the at least one beam and the first fastening device are formed in a plurality of parts.

In a further embodiment, the at least one beam, the first fastening device and the at least one further fastening device are formed in one part. Preferably, the at least one beam, the first fastening device and the at least one further fastening device are formed from the same material.

In a preferred embodiment, the at least one first fastening device is a cast element. Alternatively or additionally, in the intended fastened state, the at least one first fastening device is screwed to the charging station, in particular to a roof cladding element of the charging station. Alternatively or additionally, the at least one first fastening element has at least one coupling element, wherein the at least one coupling element is formed to accommodate the at least one beam.

Preferably, the cantilever device has exactly one beam. Alternatively, the cantilever device has exactly two beams. Alternatively, the cantilever device has exactly three beams. Alternatively, the cantilever device has exactly four beams. In particular, the number of first fastening devices is greater than or equal to the number of beams.

According to a further development of the invention, it is provided that the cantilever device has at least one charging cable accommodation. In this case, the at least one further fastening device is a second fastening device for movably fastening the at least one charging cable accommodation.

Advantageously, the at least one charging cable accommodation is configured to accommodate and/or guide a charging cable of the charging station at least in some regions. Advantageously, an action radius of the at least one charging cable is increased by means of the at least one charging cable accommodation and the at least one beam. In particular, the at least one charging cable is guided by means of the at least one charging cable accommodation in an elevated position to a motor vehicle to be charged, so that the at least one charging cable, in particular a charging plug of the at least one charging cable, can be arranged in a simple manner on the motor vehicle to be charged—in particular in a charging socket of the motor vehicle. Furthermore, the increased radius of action increases the number of possible parking positions for charging the vehicle at the charging station.

In a preferred embodiment, the at least one charging cable accommodation and the second fastening device are matched to one another in such a way that the at least one charging cable accommodation is mounted in the fastening device to be rotatable about at least one axis of rotation. Particularly preferably, the second fastening device and a connecting element of the at least one charging cable accommodation form a ball joint, so that the at least one charging cable accommodation is mounted in the fastening device to be rotatable about three axes.

In one embodiment, the second fastening device is formed in such a way, in particular as a groove and/or rail, that the at least one charging cable accommodation is displaceable in a first direction of translation. Preferably, the first direction of translation is identical to the longitudinal extension of the at least one beam.

According to a further embodiment of the invention, it is provided that the at least one beam has, as the at least one further fastening device, a third fastening device at the second end for rigidly fastening a cross strut. In particular, the at least one cross strut can be used to fasten the at least one roof element or the at least one charging cable accommodation. Advantageously, the cantilever device can be modularly and easily extended using the third fastening device.

In a preferred embodiment, the at least one third fastening device is a cast element. Alternatively or additionally, the at least one third fastening element has at least two coupling elements, wherein a first coupling element of the at least two coupling elements is formed to accommodate the at least one beam and wherein a second coupling element of the at least two coupling elements is formed to accommodate at least one cross strut. Particularly preferably, the at least one third fastening element has three coupling elements, namely the first coupling element, a first second coupling element for accommodating a first cross strut and a second second coupling element for accommodating a second cross strut.

In particular, the at least one beam and the third fastening device are formed in a plurality of parts.

Alternatively, the at least one beam and the third fastening device are formed in one part. Preferably, the at least one beam and the third fastening device are formed from the same material.

In one embodiment, the second fastening device and the third fastening device are formed in one part. Thus, the second fastening device and the third fastening device are arranged at the second end of the at least one beam.

According to a further development of the invention, it is provided that the at least one beam is formed at least in some regions as an elongate structural profile, or as a U-profile, or as an L-profile, or as a T-beam or as a double T-beam. Advantageously, the at least one beam can thus be manufactured at low cost.

In one embodiment, the at least one beam is formed as an extruded profile.

According to a further development of the invention, it is provided that the cantilever device has, as the at least one beam, a first beam and a second beam and also at least one cross strut. The at least one cross strut is configured to be fastened at one end to a first third fastening device, namely the third fastening device of the first beam, and at the other end to a second third fastening device, namely the third fastening device of the second beam. Advantageously, the cantilever device is thus formed to be more stable and rigid against forces acting on the cantilever device, in particular wind and/or tensile forces, which can occur when the charging cable and/or the at least one charging cable accommodation is displaced.

Particularly preferably, the first beam is rigidly fastened to a first position of the charging station by means of a first first fastening device. In addition, the second beam is rigidly fastened to a second position of the charging station, which is different from the first position, by means of a second first fastening device.

In particular, both the first beam and the at least one cross strut are preferably rigidly arranged on the first third fastening device, so that the first beam and the at least one cross strut are preferably rigidly connected to one another via the first third fastening device. Alternatively or additionally, both the second beam and the at least one cross strut are preferably rigidly arranged on the second third fastening device, so that the second beam and the at least one cross strut are preferably rigidly connected to one another via the second third fastening device.

In one embodiment, the at least one cross strut and the at least one third fastening device, in particular the first third fastening device and/or the second third fastening device, are formed in a plurality of parts. Alternatively, the at least one cross strut and the at least one third fastening device, in particular the first third fastening device and/or the second third fastening device, are formed in one part. Preferably, the at least one cross strut and the at least one third fastening device, in particular the first third fastening device and/or the second third fastening device, are formed from the same material.

In a further embodiment, the first beam, the second beam, the at least one cross strut, the first third fastening device and the second third fastening device are formed in a plurality of parts. Alternatively, the first beam, the second beam, the at least one cross strut, the first third fastening device and the second third fastening device are formed in one part.

According to a further development of the invention, the at least one further fastening device is arranged on the at least one beam.

In particular, the second fastening device is arranged at the second end of the at least one beam.

Alternatively or additionally, the second fastening device is arranged on the at least one beam between the first end and the second end, wherein the second fastening device is particularly preferably arranged in the intended fastened state on a surface of the at least one beam pointing geodetically downwards.

In one embodiment, the at least one beam and the second fastening device are formed in a plurality of parts. Alternatively, the at least one beam and the second fastening device are formed in one part. Preferably, the at least one beam and the second fastening device are formed from the same material.

In particular, the second fastening device is arranged on the first beam or the second beam. Preferably, a first second fastening device is arranged on the first beam. Alternatively or additionally, a second second fastening device is arranged on the second beam.

According to a further development of the invention, the at least one further fastening device is arranged on the at least one cross strut.

In particular, the second fastening device is arranged on the at least one cross strut. Preferably, the first second fastening device is arranged on the at least one cross strut. Alternatively or additionally, the second second fastening device is arranged on the at least one cross strut.

In one embodiment, the at least one cross strut and the second fastening device, in particular the first second fastening device and the second second fastening device, are formed in a plurality of parts. Alternatively, the at least one cross strut and the second fastening device, in particular the first second fastening device and the second second fastening device, are formed in one part. Preferably, the at least one beam and the second fastening device, in particular the first second fastening device and the second second fastening device, are formed from the same material.

In particular, the second fastening device is arranged on the at least one cross strut between the first end and the second end, wherein the second fastening device is particularly preferably arranged in the intended fastened state on a surface of the at least one beam pointing geodetically downwards. Preferably, the first second fastening device and/or the second second fastening device is arranged on the at least one cross strut between the first end and the second end, wherein the first second fastening device and/or the second second fastening device is particularly preferably arranged in the intended fastened state on a surface of the at least one beam pointing geodetically downwards.

According to a further development of the invention, it is provided that the at least one charging cable accommodation is arranged displaceably on the at least one cross strut in a longitudinal extension of the at least one cross strut.

In particular, the cantilever device has a first charging cable accommodation and a second charging cable accommodation as the at least one charging cable accommodation, wherein the first charging cable accommodation is arranged displaceably on the at least one cross strut in a first region in the longitudinal extension of the at least one cross strut, and wherein the second charging cable accommodation is arranged displaceably on the at least one cross strut in a second region, different from the first region, in the longitudinal extension of the at least one cross strut.

In particular, the second fastening device is formed in such a way, in particular as a groove and/or rail, that the at least one charging cable accommodation is displaceable in the longitudinal extension of the at least one cross strut.

In one embodiment, the first second fastening device is formed in such a way, in particular as a groove and/or rail, that the first charging cable accommodation is displaceable in the longitudinal extension of the at least one cross strut. Alternatively or additionally, the second second fastening device is formed in such a way, in particular as a groove and/or rail, that the second charging cable accommodation is displaceable in the longitudinal extension of the at least one cross strut.

According to a further development of the invention, the cantilever device additionally has at least one roof element. The at least one roof element may be fastened to at least one element selected from a group consisting of the first beam, the second beam, the at least one cross strut, and a combination of at least two of said elements. Furthermore, the at least one roof element is configured to at least partially cover a region delimited by the at least two beams and the at least one cross strut. Advantageously, when in the intended fastened state, the at least one roof element serves as weather protection for a user of the charging station.

In particular, the at least one roof element can be fastened to the at least one element selected from a group consisting of the first beam, the second beam, the cross strut, and a combination of at least two of said elements, by means of a fourth fastening device as the at least one further fastening device.

In one embodiment, the fourth fastening device is arranged on the first beam. In particular, the first beam and the fourth fastening device are formed in a plurality of parts. Alternatively, the first beam and the fourth fastening device are formed in one part. Preferably, the first beam and the fourth fastening device are formed from the same material.

In a further embodiment, the fourth fastening device is arranged on the second beam. In particular, the second beam and the fourth fastening device are formed in a plurality of parts. Alternatively, the second beam and the fourth fastening device are formed in one part. Preferably, the second beam and the fourth fastening device are formed from the same material.

In a further embodiment, the fourth fastening device is arranged on the at least one cross strut. In particular, the at least one cross strut and the fourth fastening device are formed in a plurality of parts. Alternatively, the at least one cross strut and the fourth fastening device are formed in one part. Preferably, the at least one cross strut and the fourth fastening device are formed from the same material.

In a further embodiment, the fourth fastening device is arranged on the at least one first fastening device. In particular, the at least one first fastening device and the fourth fastening device are formed in a plurality of parts. Alternatively, the at least one first fastening device and the fourth fastening device are formed in one part. Preferably, the at least one first fastening device and the fourth fastening device are formed from the same material.

In a further embodiment, the fourth fastening device is arranged on the at least one third fastening device. In particular, the at least one third fastening device and the fourth fastening device are formed in a plurality of parts. Alternatively, the at least one third fastening device and the fourth fastening device are formed in one part. Preferably, the at least one third fastening device and the fourth fastening device are formed from the same material.

In a preferred embodiment, a first fourth fastening device is arranged on the first beam. Additionally, a second fourth fastening device is arranged on the second beam. Additionally, a third fourth fastening device is arranged on the at least one cross strut.

According to a further development of the invention, the at least one roof element is formed as a photovoltaic module. Advantageously, the at least one roof element thus serves as an energy supply device for the charging station in the intended fastened state, so that an energy store of the charging station can be charged with electrical energy obtained from light by means of the photovoltaic module. Advantageously, this improves the carbon footprint of the charging station, as charging the electrical energy store with conventionally generated electrical energy is reduced.

Advantageously, the standby power consumption can also be covered at least partially, preferably completely, with electrical power generated by the at least one photovoltaic module, which further improves the carbon footprint. Advantageously, the at least one photovoltaic module increases the duration, in particular when operating self-sufficiently, until the energy storage unit is emptied due to the standby power consumption and without charging processes.

According to a further development of the invention, it is provided that the cantilever device has a main frame which is configured to be fastened-preferably circumferentially—in a head region of a charging station. The main frame has the first fastening device and at least one base strut. The at least one base strut is configured to be fastened at one end to the first first fastening device for fastening the first beam and at the other end to the second first fastening device for fastening the second beam. Advantageously, this further increases the stability and rigidity of the cantilever device.

The at least one base strut is formed in particular as a profiled tube, especially preferably as a square tube. In particular, the edges of the square tube are rounded.

In one embodiment, the at least one base strut is configured to be plugged and screwed to the first first fastening device and to the second first fastening device. In particular, the at least one coupling element of the first first fastening device is then formed to accommodate the at least one base strut. Additionally, the at least one coupling element of the second first fastening device is then formed to accommodate the at least one base strut.

In a preferred embodiment, the first fastening devices have at least two coupling elements, wherein the first coupling element of the at least two coupling elements is formed to accommodate the beam and at least one second coupling element of the at least two coupling elements is formed to accommodate the at least one base strut.

In a further embodiment—in particular for a charging station with a square head region-four first fastening devices and four base struts form the main frame. Preferably, each first fastening device has at least two second coupling elements for accommodating respectively two base struts.

According to a further development of the invention, it is provided that a surface of the at least one charging cable accommodation, which in the intended fastened state points geodetically upwards, is formed at least in some regions as a saddle surface. This prevents the charging cable from resting on the at least one charging cable accommodation in a point-like manner, so that a charging cable can be arranged on the surface without kinking and can be displaced with low friction relative to the at least one charging cable accommodation. Furthermore, due to the saddle surface, rotation and/or displacement of the at least one charging cable accommodation by means of the charging cable guided therein is possible easily and without kinking the charging cable.

More typically, a saddle surface has an ideal fit. The charging cable is arranged in the charging cable accommodation in such a way that the charging cable in the charging cable accommodation follows the ideal fit of the saddle surface. Preferably, the ideal fit of the saddle surface has a constant radius of curvature. Particularly preferably, the charging cable accommodation is adapted to a charging cable in such a way that the constant radius of curvature is greater than or equal to a minimum bending radius of the charging cable.

According to a further development of the invention, it is provided that the at least one charging cable accommodation forms a charging cable channel, wherein the at least one charging cable accommodation does not completely enclose the charging cable channel along a cable perimeter direction of the charging cable in an extension direction of the charging cable. In particular, the at least one charging cable accommodation is thus open on one side along the extension direction of the charging cable, so that the charging cable can be easily inserted.

According to a further development of the invention, it is provided that the at least one beam has a beam length of 80 cm to 150 cm. This allows the action radius of the cantilever device to be increased in a particularly advantageous way without impairing the stability of the cantilever device.

Preferably, the at least one beam has a beam length of 100 cm to 130 cm, particularly preferably 110 cm.

According to a further development of the invention, the cantilever device has at least one lighting device. The at least one lighting device is arranged on a surface of the at least one beam and/or the at least one cross strut pointing geodetically downwards in the intended mounted state. In particular, the lighting device is arranged on the at least one beam and/or the at least one cross strut in such a way that light emitted by the lighting device is radiated geodetically downwards.

Advantageously, this makes it possible to illuminate the area surrounding the charging station, making it easy to operate the charging station at any time of day.

The at least one lighting device is formed in particular as an LED light strip.

In one embodiment, the at least one lighting device has a lighting device energy store, wherein the lighting device energy store can be charged with electrical energy generated by the at least one photovoltaic module.

The object is also solved by creating a housing arrangement for a charging station with a housing and a cantilever device according to the invention or a cantilever device according to one or more of the aforementioned embodiments. The at least one beam is rigidly fastened to a cladding element of the housing via the first fastening device. In particular, the advantages already explained in connection with the cantilever device apply in connection with the housing arrangement.

In a particularly preferred embodiment, the first fastening device—and thus also the at least one beam—is arranged in a region of a corner in a head region of the housing. In this way, the beam extends away from the housing, starting from the corner of the housing.

In particular, the housing has a ceiling cladding element and at least one side cladding element, wherein the first fastening device is rigidly connected to the ceiling cladding element. In one embodiment, the housing has at least four side cladding elements, in particular exactly four side cladding elements.

In one embodiment, the housing envelops an inner space of a charging station at least partially, in particular completely, when used as intended, wherein in particular an installation surface-a bottom side—of the charging station is not enveloped by the housing.

According to a further development of the invention, it is provided that the at least one beam encloses an angle of −30° to 30°, preferably 10°, with an imaginary horizontal plane. Advantageously, this allows the charging cable to be guided independently of the charging station and individually at a height that is advantageous for using the charging station, thus enabling convenient use of the charging station.

In particular, in the intended state the ceiling cladding element is at least partially parallel to the horizontal plane.

In the context of the present technical teaching, the at least one beam encloses a negative angle with the imaginary horizontal plane, in particular if the at least one beam in the intended fastened state points geodetically downwards starting from the first fastening device. Furthermore, the at least one beam encloses a positive angle with the imaginary horizontal plane, in particular if the at least one beam in the intended fastened state points geodetically upwards starting from the first fastening device.

According to a further development of the invention, it is provided that a beam perpendicular direction plane and a side cladding element plane enclose an angle of 0° to 180°, preferably 135°.

In the context of the present technical teaching, the beam perpendicular direction plane is, in particular, a plane spanned by the longitudinal extension of the at least one beam and the perpendicular direction.

In the context of the present technical teaching, the side cladding element plane is, in particular, a plane spanned by a side cladding element of the housing. Preferably, the side cladding element used to determine the side cladding element plane is directly adjacent to the first fastening element.

The object is also solved by creating a charging station arrangement with a charging station and a cantilever device according to the invention or a cantilever device according to one or more of the aforementioned embodiments. Alternatively, the charging station arrangement has the charging station and a housing arrangement according to the invention or a housing arrangement according to one or more of the aforementioned embodiments. In particular, the advantages already explained in connection with the cantilever device and the housing arrangement apply in connection with the charging station arrangement.

In electrical engineering, a charging station is any device or electrical system, in particular stationary or mobile, which is used to supply energy to mobile battery-powered devices, machines or motor vehicles by simply plugging them in without necessarily having to remove the energy storage system-such as the traction battery of an electric car. Charging stations for electric cars are sometimes also referred to as “electric charging stations” and can include a plurality of charging points. High performance charging systems or high power charging system (HPC systems) such as the combined charging system (CCS), which is widespread in Europe, are particularly well known. With generic direct current charging, direct current from the charging station is fed directly into the vehicle's battery and provided by a powerful rectifier, preferably of the charging station, from the power grid or by large buffer accumulators at solar charging stations, for example. There is a battery management system in the vehicle that communicates directly or indirectly with the charging station to adjust the current and voltage or to terminate the process when a predetermined capacity limit is reached. Power electronics are usually located in the charging station. Since the direct current connections of the charging station are connected directly to the corresponding connections of the traction battery-without a detour through an AC/DC converter of the vehicle-high charging currents can be transmitted with low losses, which enables short charging times.

In one embodiment, the charging station is designed as a charging column. In particular, the charging station has at least one charging point, in particular exactly one charging point or exactly two charging points.

In particular, the charging station is designed as a fast charging station. In one embodiment, the charging station is designed as a battery-supported charging station, in particular as a battery-supported fast charging station.

According to a further development of the invention, it is provided that the charging station arrangement has at least one charging cable. The at least one charging cable is guided over the at least one charging cable accommodation, in particular the saddle surface of the at least one charging cable accommodation, of the cantilever device. In particular, a length of the at least one charging cable is selected such that the at least one charging cable does not touch the ground when not in use—and thus when arranged in the charging plug suspension. Preferably, the charging cable has a length of at least 2 m.

In a further embodiment, the charging station has two charging points and thus two charging cables and two charging cable accommodations, wherein a first charging cable is guided via the one first charging cable accommodation and a second charging cable is guided via a second charging cable accommodation. Advantageously, this makes it possible to charge two vehicles simultaneously in a simple and convenient manner and without a prescribed alignment of the vehicles relative to each other and/or relative to the charging station.

The invention also includes a cantilever device kit with at least one beam, at least one first fastening device, at least one further fastening device and assembly instructions. The assembly instructions contain information on how to assemble the cantilever device as intended and how to mount it on a charging station.

The invention is explained in more detail below with reference to the drawing. The Figures show:

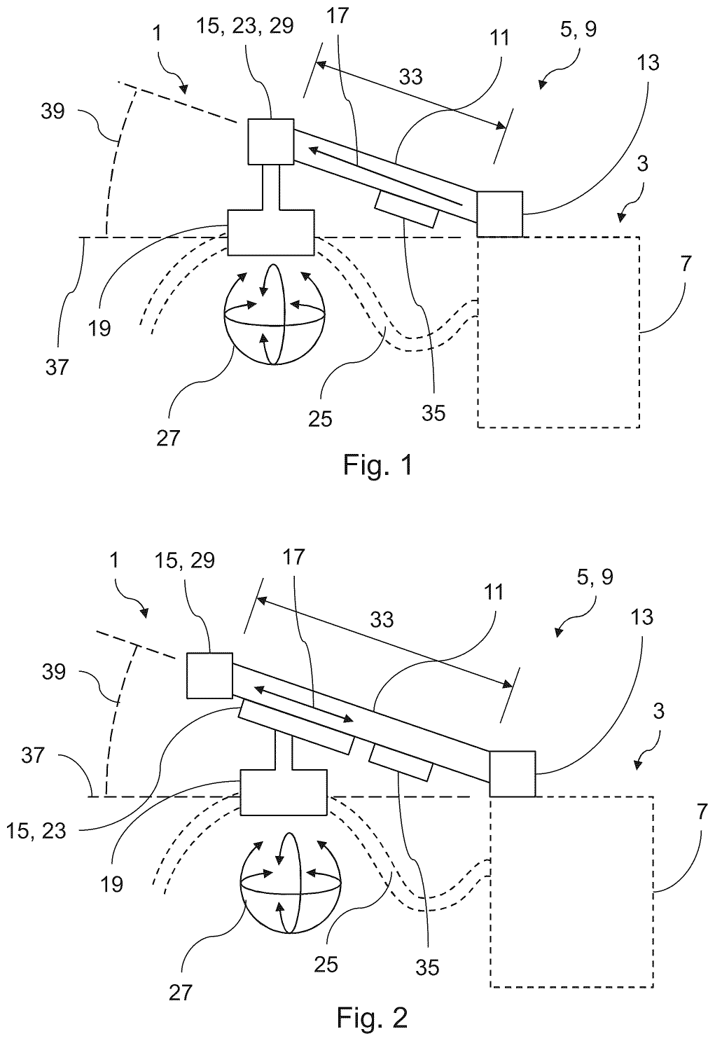

FIG. 1 shows a schematic representation of a first embodiment example of a cantilever device in a side view,

FIG. 2 shows a schematic representation of a second embodiment example of the cantilever device in a side view,

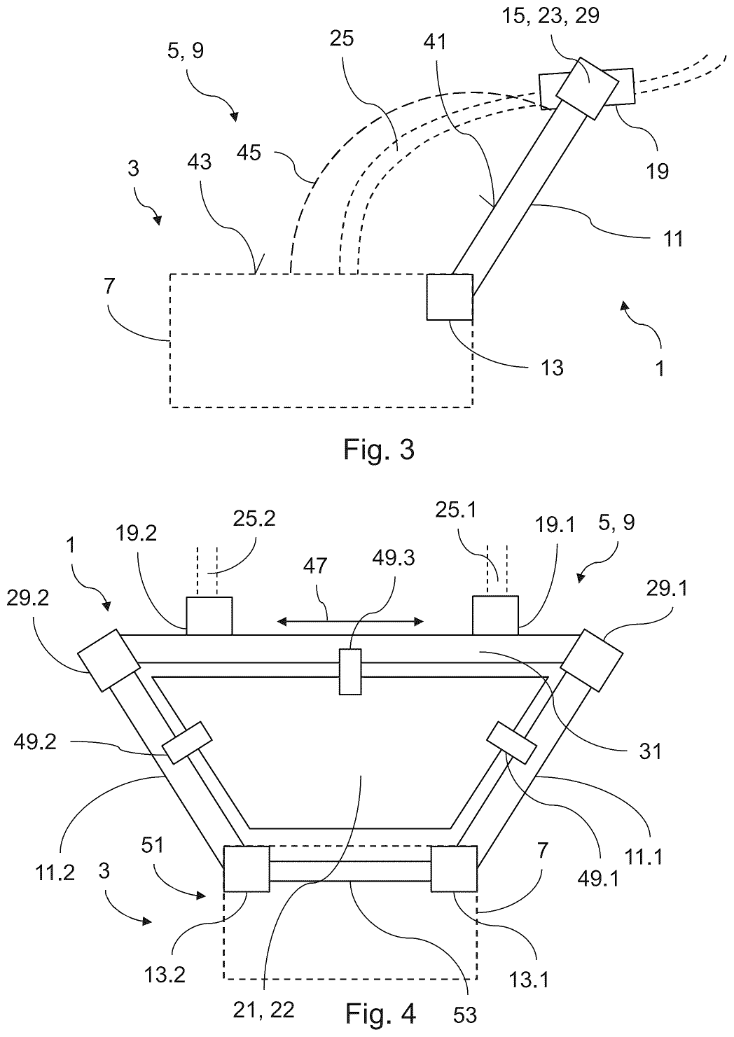

FIG. 3 shows a schematic representation of the first embodiment example of the cantilever device in a top view,

FIG. 4 shows a schematic representation of a third embodiment example of the cantilever device in a top view,

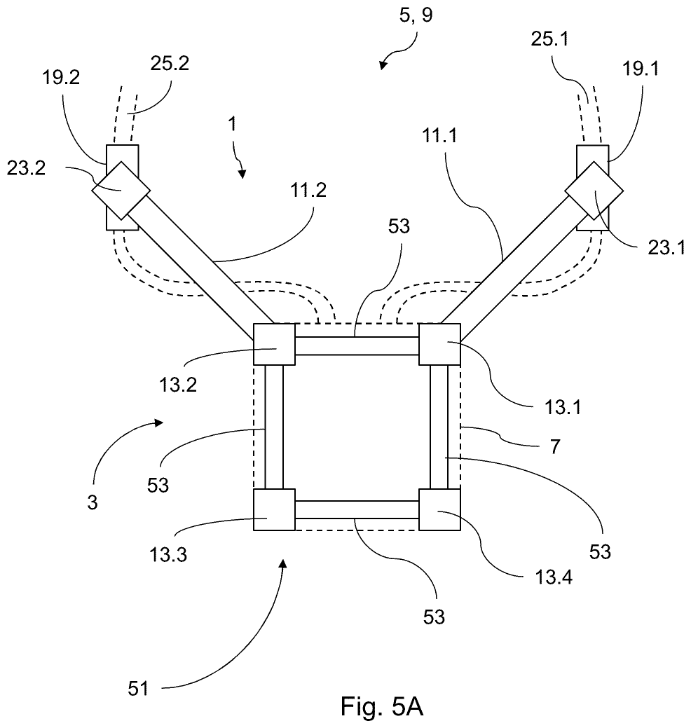

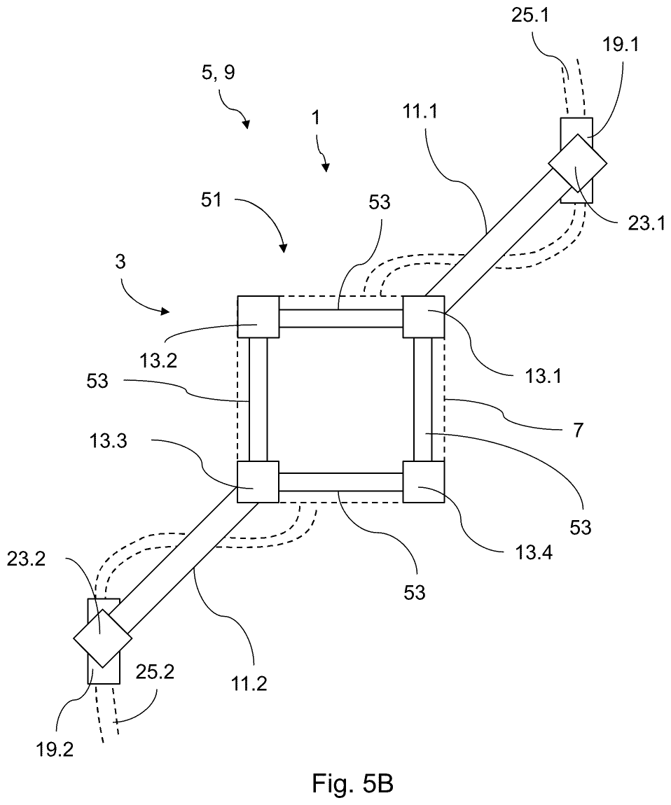

FIG. 5A shows a schematic representation of a fourth embodiment example of the cantilever device in a top view,

FIG. 5B shows a schematic representation of a fifth embodiment example of the cantilever device in a top view,

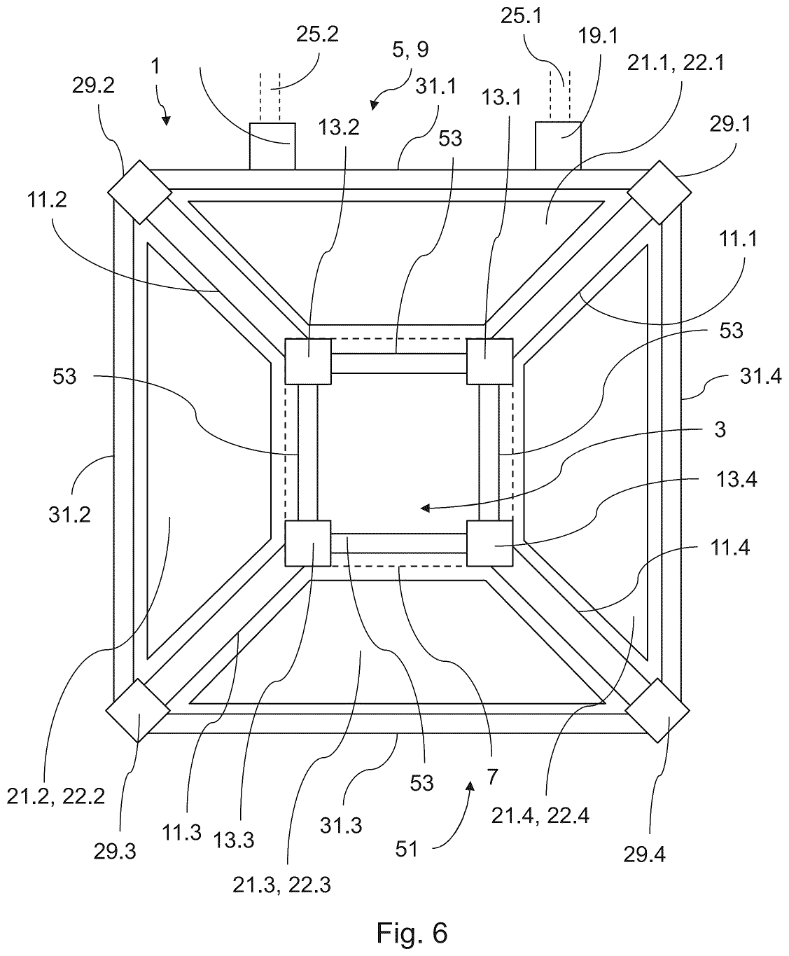

FIG. 6 shows a schematic representation of a sixth embodiment example of the cantilever device in a top view,

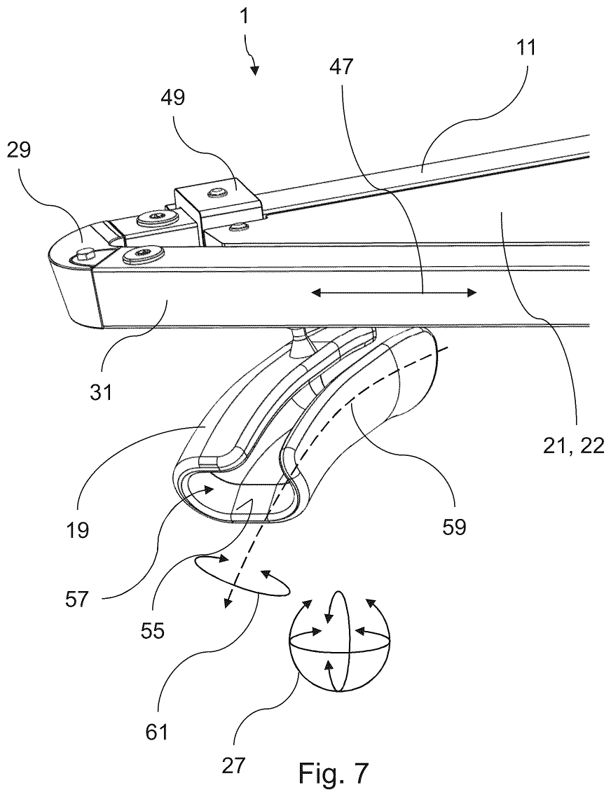

FIG. 7 shows a schematic representation of a seventh embodiment example of the cantilever device in a detailed view,

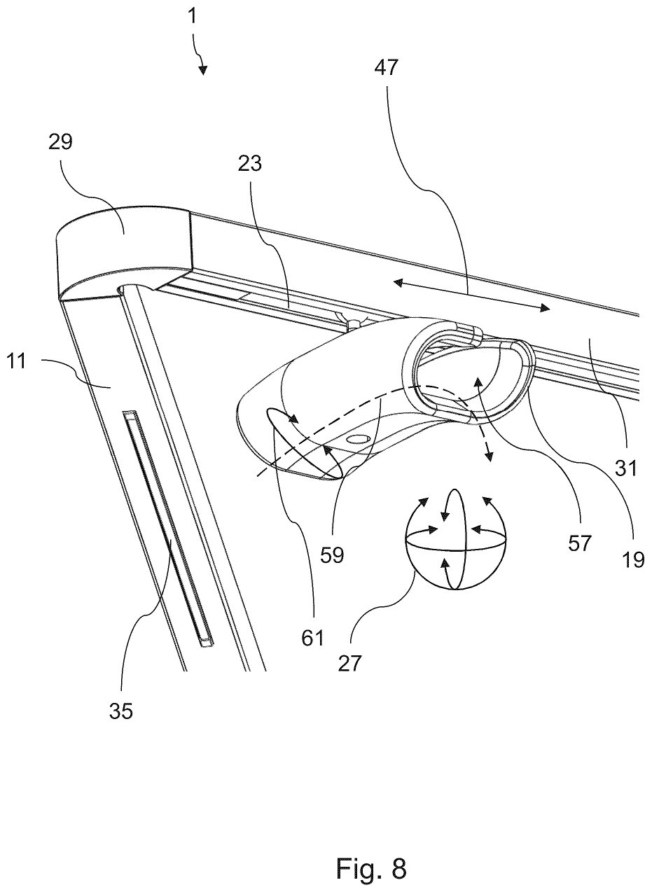

FIG. 8 shows a schematic representation of the seventh embodiment example of the cantilever device in a detailed view,

FIG. 1 shows a schematic representation of a first embodiment example of a cantilever device 1 for a charging station 3 in a side view.

In particular, the cantilever device 1 and the charging station 3 form a charging station arrangement 5. Alternatively or additionally, the cantilever device 1 and a housing 7 of the charging station 3 form a housing arrangement 9.

The cantilever device 1 has a beam 11, a first fastening device 13 and at least one further fastening device 15. The beam 11 has a rigid main body with a first end and a second end opposite the first end along a longitudinal extension 17 of the beam 11. The first fastening device 13 is formed for rigidly fastening the first end of the beam 11 to the charging station 3. In addition, the at least one further fastening device 15 is formed for movably fastening a charging cable accommodation 19 and/or at least one roof element 21-shown in FIGS. 4, 6 and 7.

Optionally, the cantilever device 1 has the charging cable accommodation 19. The at least one further fastening device 15 is a second fastening device 23 for movably fastening the charging cable accommodation 19. In particular, a charging cable 25 of the charging station 3 is guided via the charging cable accommodation 19.

Particularly preferred, the charging cable accommodation 19 and the second fastening device 23 are matched to one another in such a way that the charging cable accommodation 19 is mounted in the fastening device to be rotatable about at least one axis of rotation. The rotatability of the charging cable accommodation 19 is shown by the arrows 27.

Optionally, the beam 11 has, as the at least one further fastening device 15, a third fastening device 29 at the second end for rigidly fastening a cross strut 31-shown in FIGS. 4 to 8. In particular, the cross strut 31 can be used for fastening a roof element 21 or the charging cable accommodation 19.

In particular, the beam 11 has a beam length 33 of 80 cm to 150 cm, preferably of 100 cm to 130 cm, particularly preferably of 110 cm.

Optionally, the cantilever device 1 has a lighting device 35, wherein the lighting device 35 is designed in particular as an LED light strip. The lighting device 35 is arranged on a surface of the beam 11 and/or the cross strut 31 pointing geodetically downwards in the intended mounted state. In particular, the lighting device 35 is arranged on the beam 11 and/or the cross strut 31 in such a way that light emitted by the lighting device 35 is radiated geodetically downwards.

Particularly preferably, the beam 11 and an imaginary horizontal plane 37 enclose an angle 39 of −30° to 30°, preferably 10°.

FIG. 2 shows a schematic representation of a second embodiment example of the cantilever device 1 for the charging station 3 in a side view.

Identical and functionally identical elements are provided with identical reference numbers in all Figures, so that reference is made to the previous description in this respect.

In contrast to the first embodiment example according to FIG. 1, in the second embodiment example according to FIG. 2, the second fastening device 23 is arranged on the beam 11 between the first end and the second end on a surface of the beam 11 pointing geodetically downwards in the intended fastened state. Alternatively or in addition to the rotatable fastening of the charging cable accommodation 19, the second fastening device 23 is additionally formed in such a way that the charging cable accommodation 19 is displaceable in the longitudinal extension 17 of the beam 11.

FIG. 3 shows a schematic representation of the first embodiment example of the cantilever device 1 in a top view.

For a clearer representation, the movement directions 27, the longitudinal extension 17 of the beam 11 and the beam length 33 are not shown.

In particular, a beam perpendicular direction plane 41 and a side cladding element plane 43 enclose an angle 45 of 0° to 180°, preferably 135°. The beam perpendicular direction plane 41 and the side cladding element plane 43 are perpendicular to the drawing plane.

FIG. 4 shows a schematic representation of a third embodiment example of the cantilever device 1 in a top view.

Analogous to FIG. 3, for a clearer representation, the movement directions 27 of the charging cable accommodation 19, the longitudinal extension 17 of the beam 11 and the beam length 33 are not shown. Furthermore, for a clearer representation, the orientation of the beam 11 is not shown, in particular the angles 39 and 45.

The cantilever device 1 has a first beam 11.1 and a second beam 11.2, as well as the cross strut 31.

The cross strut 31 is configured to be fastened at one end to a first third fastening device 29.1 and at the other end to a second third fastening device 29.2.

In particular, the first beam 11.1 is rigidly fastened to a first position of the charging station 3 by means of a first first fastening device 13.1. In addition, the second beam 11.2 is rigidly fastened to a second position of the charging station 3, which is different from the first position, by means of a second first fastening device 13.2.

In particular, both the first beam 11.1 and the cross strut are rigidly arranged on the first third fastening device 29.1, so that the first beam 11.1 and the cross strut 31 are rigidly connected to one another via the first third fastening device 29.1. Alternatively or additionally, both the second beam 11.2 and the cross strut 31 are rigidly arranged on the second third fastening device 29.2, so that the second beam 11.2 and the cross strut 31 are rigidly connected to one another via the second third fastening device 29.2.

Optionally, a first second fastening device—not visible in the top view—is arranged on the cross strut 31. Alternatively or additionally, a second second fastening device—not visible in the top view—is arranged on the cross strut 31. The cantilever device 1 optionally has a first charging cable accommodation 19.1 and/or a second charging cable accommodation 19.2. The first charging cable accommodation 19.1 and/or the second charging cable accommodation 19.2 is arranged displaceably on the cross strut 31 in a longitudinal extension 47 of the cross strut 31, in particular via the first second fastening device and/or the second second fastening device. Furthermore, in particular, a first charging cable 25.1 and/or a second charging cable 25.2 of the charging station 3 is guided via the first charging cable accommodation 19.1 and/or the second charging cable accommodation 19.2.

Optionally, the cantilever device additionally has a roof element 21. The roof element 21 may be fastened to at least one element selected from a group consisting of the first beam 11.1, the second beam 11.2, the cross strut 31, and a combination of at least two of said elements. Furthermore, the roof element 31 is configured to at least partially cover a region delimited by the first beam 11.1, the second beam 11.2, the cross strut 31.

In particular, the roof element 21 is fastened to the first beam 11.1 by means of a first fourth fastening device 49.1. Alternatively or additionally, the roof element 21 is fastened to the second beam 11.2 by means of a second fourth fastening device 49.2. Alternatively or additionally, the roof element 21 is fastened to the cross strut 31 by means of a third fourth fastening device 49.3.

The roof element 21 is particularly preferably formed as a photovoltaic module 22.

Optionally, the cantilever device 1 has a main frame 51 which is configured to be fastened-preferably circumferentially—in a head region of a charging station 1. The main frame 51 has the first fastening device 13.1 and a base strut 53. The one base strut is configured to be fastened at one end to the first first fastening device 13.1 and at the other end to the second first fastening device 13.2.

FIGS. 5A and 5B show a schematic representation of a fourth and fifth embodiment example of the cantilever device 1 in a top view respectively.

Analogous to FIGS. 3 and 4, for a clearer representation, the movement directions 27 of the charging cable accommodation 19, the longitudinal extension 17 of the beam 11 and the beam length 33 are not shown. Furthermore, analogous to FIG. 4, for a clearer representation, the orientation of the beam 11 is not shown, in particular the angles 39 and 45.

The main frame 51 of the cantilever device 1 has the first first fastening device 13.1, the second first fastening device 13.2, a third first fastening device 13.3, a fourth first fastening device 13.4, and four base struts 53.

In FIGS. 5A and 5B, the first beam 11.1 is rigidly connected to the first first fastening device 13.1. Furthermore, in FIG. 5A the second beam 11.2 is rigidly connected to the second first fastening device 13.2. In FIG. 5B, the second beam 11.2 is rigidly connected to the third first fastening device 13.3.

FIG. 6 shows a schematic representation of a sixth embodiment example of the cantilever device 1 in a top view.

Analogous to FIGS. 3, 4, and 5A and 5B, for a clearer representation, the movement directions 27 of the charging cable accommodation 19, the longitudinal extension 17 of the beam 11 and the beam length 33 are not shown. Furthermore, analogous to FIGS. 4 and 5, for a clearer representation, the orientation of the beam 11 is not shown, in particular the angles 39 and 45.

Furthermore, for a clearer representation, the fourth fastening devices 49 for fastening the roof elements 21, in particular the photovoltaic modules 22, are not shown.

The cantilever device 1 has the first beam 11.1, the second beam 11.2, a third beam 11.3 and a fourth beam 11.4. The first beam 11.1 is rigidly connected to the first fastening device 13.1. Furthermore, the second beam 11.2 is rigidly connected to the second first fastening device 13.2.

In addition, the third beam 11.3 is rigidly connected to the third first fastening device 13.3. And the fourth beam 11.4 is rigidly connected to the fourth first fastening device 13.4.

Furthermore, the first beam 11.1 and the second beam 11.2 are rigidly connected to one another via a first cross strut 31.1, the first third fastening device 29.1 and the second third fastening device 29.2. The second beam 11.2 and the third beam 11.3 are rigidly connected to one another via a second cross strut 31.2, the second third fastening device 29.2 and a third third fastening device 29.3. In addition, the third beam 11.3 and the fourth beam 11.4 are rigidly connected to one another via a third cross strut 31.3, the third third fastening device 29.3 and a fourth third fastening device 29.4. Furthermore, the fourth beam 11.4 and the first beam 11.4 are rigidly connected to one another via a fourth cross strut 31.4, the fourth third fastening device 29.4 and the first third fastening device 29.1.

Optionally, the cantilever device 1 has a first roof element 21.1, in particular a first photovoltaic module 22.1, wherein the first roof element 21.1 is connected to the first beam 11.1, the second beam 11.2 and/or the first cross strut 31.1 via at least one fourth fastening device 49. Alternatively or additionally, the cantilever device 1 has a second roof element 21.2, in particular a second photovoltaic module 22.2, wherein the second roof element 21.2 is connected to the second beam 11.2, the third beam 11.3 and/or the second cross strut 31.2 via at least one fourth fastening device 49. Alternatively or additionally, the cantilever device 1 has a third roof element 21.3, in particular a third photovoltaic module 22.3, wherein the third roof element 21.3 is connected to the third beam 11.3, the fourth beam 11.4 and/or the third cross strut 31.3 via at least one fourth fastening device 49. Alternatively or additionally, the cantilever device 1 has a fourth roof element 21.4, in particular a fourth photovoltaic module 22.4, wherein the fourth roof element 21.4 is connected to the first beam 11.1, the fourth beam 11.4 and/or the fourth cross strut 31.4 via at least one fourth fastening device 49.

Optionally, the first charging cable accommodation 19.1 and the second charging cable accommodation 19.2 are arranged on the first cross strut 31.1. Alternatively, the first charging cable accommodation 19.1 is arranged on the first cross strut 31.1 and the second charging cable accommodation 19.2 is arranged on the second cross strut 31.2. Alternatively, the first charging cable accommodation 19.1 is arranged on the first cross strut 31.1 and the second charging cable accommodation 19.2 is arranged on the third cross strut 31.3.

FIG. 7 shows a schematic representation of a seventh embodiment example of the cantilever device 1 in a detailed view looking diagonally downwards.

The charging cable accommodation 19 is arranged on the cross strut 31 as shown in FIG. 4. The charging cable accommodation 19 is arranged on the cross strut 31 such that it is displaceable along the longitudinal extension 47 of the cross strut 31. Alternatively or additionally, the charging cable accommodation 19 is arranged rotatably about at least one axis of rotation on the cross strut 31, shown by the arrows 27.

A surface 55 of the charging cable accommodation 19 pointing geodetically upwards in the intended fastened state is formed as a saddle surface, at least in some regions. In addition, the charging cable accommodation 19 forms a charging cable channel 57, wherein the charging cable accommodation 19 does not completely enclose the charging cable channel 57 along a cable perimeter direction 61 encompassing an extension direction 59 of the charging cable 25—not shown here. In particular, the charging cable accommodation 19 is thus open on one side along the extension direction 59 of the charging cable 25, so that the charging cable 25 can be easily inserted.

FIG. 8 shows a schematic representation of the seventh embodiment example of the cantilever device 1 in a further detailed view looking diagonally upwards.

The optional roof element 21 is not shown here.

The second fastening device 23 is formed as a groove and/or rail on a surface of the cross strut 31 pointing geodetically downwards. Thus, the charging cable accommodation 19 is displaceable in the longitudinal extension 47 of the cross strut 31.

1. A cantilever device for a charging station with at least one beam, wherein
the at least one beam has a rigid main body with a first end and a second end opposite the first end along a longitudinal extension of the at least one beam, wherein
the cantilever device has a first fastening device for rigidly fastening the first end of the at least one beam to the charging station, wherein
the cantilever device has at least one further fastening device, for movably fastening at least one charging cable accommodation and/or at least one roof element.

2. The cantilever device according to claim 1, wherein the cantilever device has at least one charging cable accommodation, and wherein the at least one further fastening device is a second fastening device for movably fastening the at least one charging cable accommodation.

3. The cantilever device according to claim 1, wherein the at least one beam has, as the at least one further fastening device, a third fastening device at the second end for rigidly fastening a cross strut.

4. The cantilever device according to claim 1, wherein the at least one beam is formed at least in some regions as an elongate structural profile, or as a U-profile, or as an L-profile, or as a T-beam or as a double T-beam.

5. The cantilever device according to claim 1, wherein the cantilever device has, as the at least one beam a first beam and a second beam, and also at least one cross strut which is configured to be fastened at one end to the third fastening device of the first beam and at the other end to the third fastening device of the second beam.

6. The cantilever device according to claim 1, wherein the at least one further fastening device, is arranged on the at least one beam and/or on the at least one cross strut.

7. The cantilever device according to claim 5, wherein the at least one charging cable accommodation is arranged displaceably on the at least one cross strut in a longitudinal extension of the at least one cross strut.

8. The cantilever device according to claim 5 with at least one roof element, wherein the roof element in particular by means of a fourth fastening device as the at least one further fastening device, can be fastened to at least one element selected from a group consisting of the first beam, the second beam, the cross strut, and a combination of at least two of said elements, wherein the at least one roof element is configured to at least partially cover a region delimited by the at least two beams and the at least one cross strut.

9. The cantilever device according to claim 8, wherein the at least one roof element is formed as a photovoltaic module.

10. The cantilever device according to claim 1, with a main frame which is configured to be fastened-preferably circumferentially—in a head region of a charging station, wherein the main frame has the first fastening device, as well as at least one base strut which is configured to be fastened at one end to a first first fastening device for fastening the first beam and at the other end to a second first fastening device for fastening the second beam.

11. The cantilever device according to claim 1, wherein a surface of the at least one charging cable accommodation pointing geodetically upwards in the intended fastened state is formed at least in some regions as a saddle surface.

12. The cantilever device according to claim 1, wherein the at least one charging cable accommodation forms a charging cable channel, wherein the at least one charging cable accommodation does not completely enclose the charging cable channel along a cable perimeter direction encompassing an extension direction of the charging cable.

13. The cantilever device according to claim 1, wherein the at least one beam has a beam length from 80 cm to 150 cm, in particular from 100 cm to 130 cm.

14. The cantilever device according to claim 1 with at least one lighting device, in particular an LED light strip, wherein the lighting device is arranged on a surface of the at least one beam and/or the at least one cross strut pointing downwards in the intended mounted state.

15. A housing arrangement for a charging station with a housing and a cantilever device according to claim 1, wherein the at least one beam is rigidly fastened to a cladding element of the housing via the first fastening device.

16. The housing arrangement according to claim 15, wherein the at least one beam encloses an angle of −30° to 30°, preferably 10°, with an imaginary horizontal plane.

17. The housing arrangement according to claim 15, wherein a beam perpendicular direction plane and a side cladding element plane enclose an angle of 0° to 180°, preferably 135°.

18. A charging station arrangement with a charging station and a cantilever device according to claim 1.

19. The charging station arrangement according to claim 18 with at least one charging cable, wherein the at least one charging cable is guided via the at least one charging cable accommodation of the cantilever device.

20. A charging station arrangement with a charging station and a cantilever device or a housing arrangement according to claim 15.
